(19) United States
(12) Patent Application Publication
(10) Pub. No.: US 2002/0112175 A1
(43) Pub. Date: Aug. 15, 2002

(54) Conditional access for functional units

(76) Inventors: Douglas S. Makofka, Willow Grove, PA (US); John Okimoto, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/736,617

(22) Filed: Dec. 13, 2000

(51) Int. Cl. H04L 9/32

(52) U.S. Cl. 713/200

(57) ABSTRACT

The invention relates to controlling functional units within a conditional access system. In one embodiment, a method for controlling access to a functional unit within a set top box is described. In one step, first information comprising a plurality of functional unit identifiers and one or more tier requirements respectively related to each functional unit identifier is received. Second information comprising tier rights is also received. The functional unit identifiers are correlated to their respective tier requirements. The functional unit is interacted with. It is determined if the respective tier requirements are satisfied by the tier rights. Further interaction with the functional unit is authorized.

### BACKGROUND OF THE INVENTION

This invention relates in general to conditional access systems and, more specifically, to controlling functional units within a conditional access system.

Cable television (TV) providers distribute video streams to subscribers by way of conditional access (CA) systems. CA systems distribute video streams from a headend of a multiple system operator (MSO) to a set top box associated with a subscriber. The headend includes hardware that receives the video streams and distributes them to the set top boxes within the CA system. Select set top boxes are allowed to decode certain video streams according to entitlement information sent by the MSO to the set top box. These video streams are volatile and are not retained by the set top box.

Video programs are distributed in either digital form or analog form to the set top boxes. There are around one hundred and twenty analog carrier channels in most cable television systems. The carrier channels either carry an analog video stream or carry multiple digital video streams. The analog video feed is modulated on a carrier and occupies the whole carrier channel for the one analog video feed. To maximize bandwidth, about eight to fourteen digital video streams may be multiplexed on the same carrier channel. The separate digital video streams are separated by packet identification (PID) information such that the individual content streams can be removed according to their unique PID information.

Video streams are broadcast to all set top boxes, but only a subset of those boxes is given access to specific video streams. For example, only those that have ordered a pay per view boxing match are allowed to view it even though every set top box may receive the match. Once a user orders the pay per view program, an entitlement message is singlecasted in encrypted form to each entitled set top box. Only the particular set top box the entitlement message is singlecasted to can decrypt it. Inside the decrypted entitlement message is a key that will decrypt the pay per view program. With that key, the set top box decrypts the pay per view program as it is received in real-time as either an analog or digital video stream. Accordingly, only whole video streams are entitled during download.

Some systems, that do not provide conditional access, integrate personal computing with a TV for displaying non-streaming media, such as software programs. For example, products such as WebTV™ integrate web browsing and e-mail programs with a TV. In these systems, a personal computer (PC) is housed near the TV. The PC is connected to an Internet service provider (ISP) that provides the content for the web browsing and e-mail programs. These systems provide content without checking entitlements as is desired in conditional access systems.

### SUMMARY OF THE INVENTION

The invention relates to controlling functional units within a conditional access system. In one embodiment, a method for controlling access to a functional unit within a set top box is described. In one step, first information comprising a plurality of functional unit identifiers and one or more tier requirements respectively related to each functional unit identifier is received. Second information comprising tier rights is also received. The functional unit identifiers are correlated to their respective tier requirements. The functional unit is interacted with. It is determined if the respective tier requirements are satisfied by the tier rights. Further interaction with the functional unit is authorized.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

FIG. 1 is a block diagram showing one embodiment of system for distributing control data information;

FIG. 2 is a block diagram showing one embodiment of a content delivery system;

FIG. 3 is a block diagram illustrating an embodiment of a set top box interfaced to its environment;

FIG. 4 is a block diagram depicting an embodiment of an object message;

FIG. 5 is a block diagram showing an embodiment of a “rights” message;

FIG. 6 is a block diagram showing an embodiment of an object “requirements” message;

FIG. 7 is a block diagram showing an embodiment of a resources “requirements” message;

FIG. 8 is a block diagram showing the relationship between different objects in a set top box;

FIG. 9 is a block diagram illustrating an embodiment of interaction between functional units;

FIG. 10 is a flow diagram showing an embodiment of a process for distributing functional units;

FIG. 11 is a flow diagram depicting an embodiment of a process for sending control data information; and

FIG. 12 is a flow diagram illustrating an embodiment of a process for receiving control data information.

### DESCRIPTION OF THE SPECIFIC EMBODIMENTS

The present invention validates that functional units, such as software programs, are authorized for use within a television (TV) set top box by using a tier mechanism. Authorization is provided by mapping between tier requirements and tier rights for the resource. If the tier requirements for a particular functional unit are satisfied by the tier rights, the functional unit is authorized for use in the set top box.

In the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

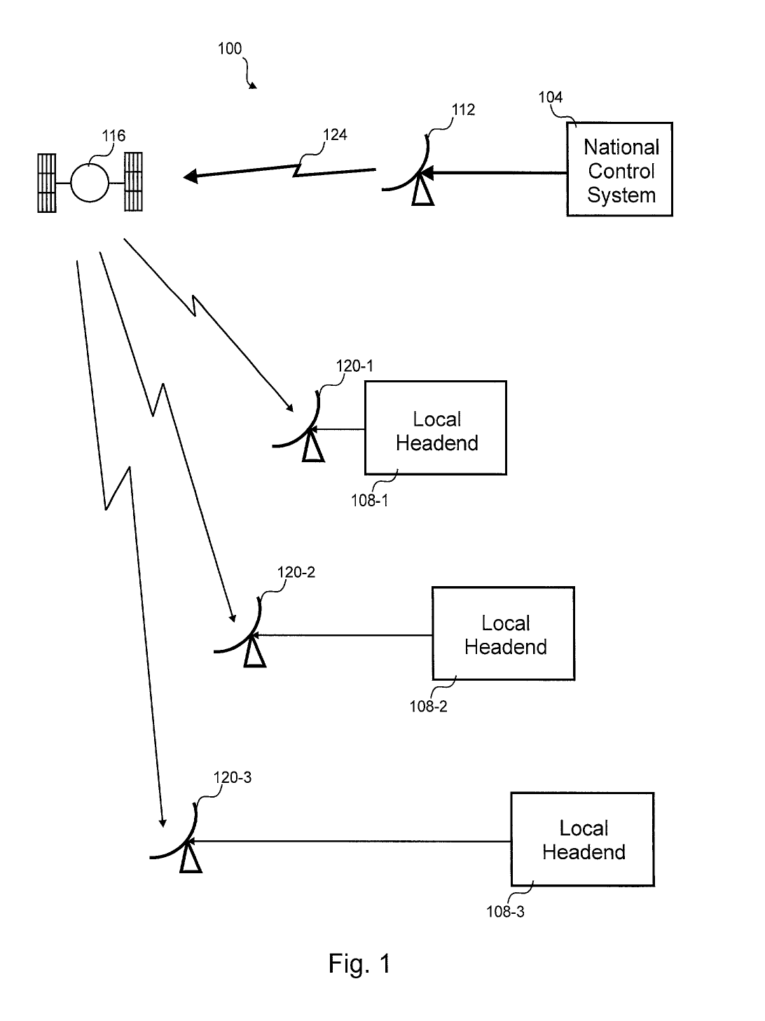

Referring first to FIG. 1, an embodiment of a system 100 is shown that distributes control information such as functional units and entitlements for those functional units. This embodiment 100 uses a national control system 104 to distribute control information from a number of local headends 108 using headend in the sky (HITS) data streams 124. The national control system 104 functions as a multiple system operators (MSOs) and also distributes authorization information for local headends 108. Billing information from the MSOs associated with each local headend 108 is fed to the national control system 104 where the control information is put into a HITS data stream 124 for that local headend. The A control data satellite 116 and satellite dishes 112, 120 are used to relay the HITS data streams 124 from the national control system 104 back to the local headends 108.

The content distributed by local headends 108 includes streaming media and functional units. Streaming media is video or audio programs that are received, decoded, decrypted and displayed in real time such that the streaming content is not stored in set top box of the user. Streaming media is transient or volatile, and functional units are non-transient or non-volatile. If any streaming media is located in memory, it is lost when the set top box is powered-down. The local headend 108 could be owned by the national control system MSO or by other MSOs who rely upon the national control system 104 to provide authorization information to the local headend 108 of the other MSO.

Functional units are discrete entities that are either hardware or implemented in software, for example, a parallel port, a serial port, a universal serial bus (USB) port, a fire wire (i.e., IEEE 1394) port, an ethernet port, a smart card interface, a packet switched network subsystem, an infrared transceiver, firmware, data, non-streaming video, non-streaming audio, an e-mail program, an operating system, application software, drivers, or other software programs. Functional units include objects and resources and remain stored in the set top box when it is powered-down. Objects include any collection of digital information that can be digitally sent to and stored in the set top box. Resources include anything that is inside the set top box and that is needed by an object to operate as intended, such as another object or a physical device.

An object may have several functions associated with it that are also resources such that the use of the object is subject to authorization as well as the several functions. For example, an e-mail program is a software object. The ability of the e-mail program to print or read certain attachments is a resource. A user could be given the ability to read e-mail with the program, but the ability to print e-mail from the program could be inhibited unless additional authorization tiers are procured.

The HITS data streams 124 are control data channels used for distribution of control data information to the local headends 108. The national control system 104 modulates the HITS data streams 124 onto out-of-band channels respectively uplinked to all local headends 108.

Although this embodiment distributes control data information through the national control system 104 as an intermediary, other embodiments need not use the national control system 104. Larger MSOs, for example, may have their own equipment for sending control data information to the set top boxes. These larger MSOs would formulate the control data information for broadcast directly to the set top boxes in their domain. The control data information could be sent on an out-of-band stream, an in-band control channel stream, a DigiCipher II™ broadcast service data stream, a data over cable system interface specification (DOCSIS) service stream, or other control data channel as part of a broadcast, multicast or singlecast transmission.

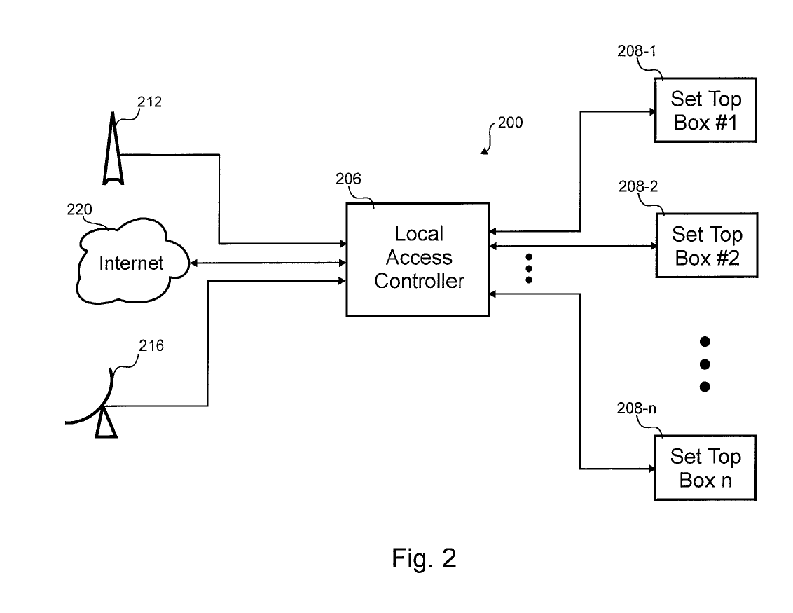

With reference to FIG. 2, a block diagram of one embodiment of a content delivery system 200 is shown. The delivery system 200 selectively provides content to a number of users based upon certain conditions being satisfied. Included in the system 200 are a local access controller 206, a number of set top boxes 208, a local programming receiver 212, a content satellite dish 216, and the Internet 220.

The local access controller 206 receives content and distributes it to users and manages billing for the tiers of service ordered by each user that enable use of the content. A MSO may have a number of local access controllers and/or local headends to distribute content for the MSO. The streaming media portion of the content is received from a variety of sources that could include the content satellite dish 216, the local programming receiver 212, a microwave receiver, a packet switched network, the Internet 220, etc. Each set top box 208 has a unique address that allows sending entitlement information to an individual set top box 208. In this way, one set top box 208-1 might be entitled to some particular functional unit while another set top box 208-2 might not even though both boxes 208-1, 208-2 receive the functional unit. Equipment within the local access controller 206 regulates the subset of set top boxes 208 that are entitled to the functional unit and bills the party receiving that functional unit appropriately.

The content is typically distributed in digital form with an analog carrier channel that contains a number of separate digital streams. All the digital streams or channels are multiplexed together into a single digital stream that is modulated upon the analog carrier channel. There are around one hundred and twenty analog carrier channels in this embodiment of the system 200. The separate digital streams are tracked by packet identification (PID) information such that the individual digital streams can be removed according to their unique PID information. Other embodiments could distribute the content with transport mechanisms that include satellite dishes, microwave antennas, RF transmitters, packet switched networks, cellular data modems, carrier current, phone lines, and/or the Internet.

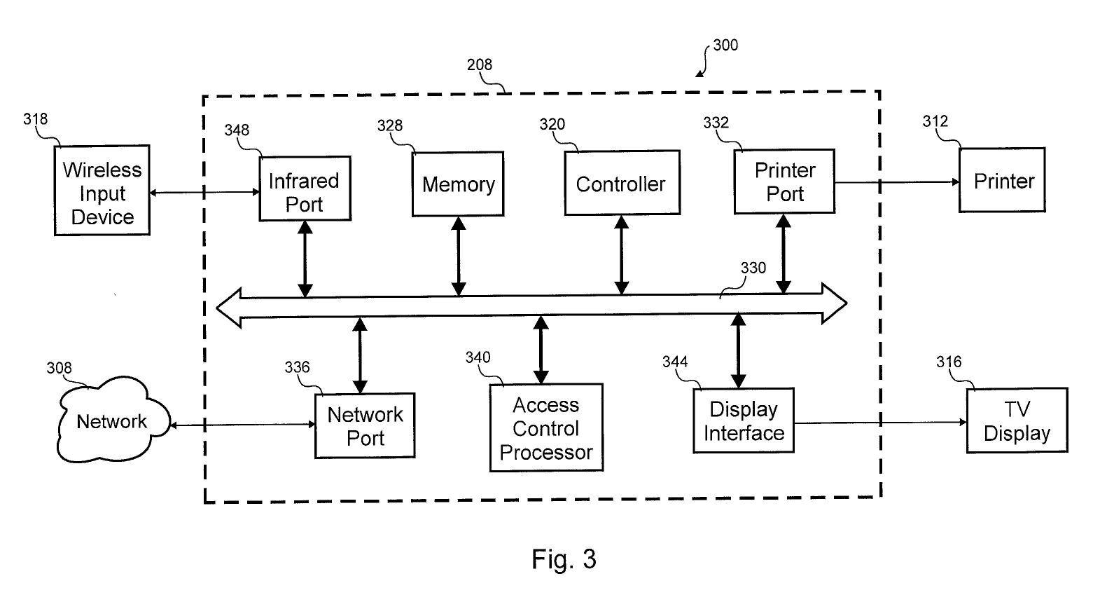

Referring next to FIG. 3, a block diagram of an embodiment of a display system 300 is shown. This embodiment provides multiple levels of object and resource security through a variety of security mechanisms. Included in the display system 300 are a set top box 208, network 308, printer 312, TV display 316, and wireless input device 318. These items cooperate in such a way that the user can enjoy content conditionally distributed by a content provider. In this embodiment, the content provider is a cable TV provider or MSO.

The network 308 serves as the conduit for information traveling between the set top box 208 and the headend of the MSO. In this embodiment, the network has one hundred and twenty analog carriers and a bi-directional control data channel. Generally, each analog carrier transports either an analog channel or a number of digital channels, and the control data channel transports objects and entitlement information. Each of the digital channels on the analog carrier are distinguished by packet identifiers (PIDs).

The bi-directional control channel is an out-of-band channel that broadcasts data to the set top boxes 208 at one frequency and receives data from the boxes 208 at another frequency. Return data may be queued to decrease overloading during peak use periods using a store and forward methodology well known in the art. Other embodiments could use an in-band channel, a cable modem, digital subscriber line (DSL), cellular data, satellite links, microwave links, or carrier current techniques to distribute control data information. Further embodiments could use a uni-directional control channel instead of a bi-directional control channel to send control data information. In this scenario, functional units could be authorized without feedback from the set top box 208.

The printer 312 is an optional accessory some users may purchase and add to their display system 300. When using the set top box 208 for personal computer tasks, the printer 312 allows printing data such as email, web pages, billing information, etc. As will be explained further below, the ability to use a functional unit, such as a printer port 332, is regulated by an authorization mechanism controlled by the MSO. Using this regulation feature, printers 312 compatible with the set top box 208 do not work unless proper authorization is obtained to enable the printer port 332 for that set top box 208.

The TV display 316 presents the user with audio, text and/or video corresponding to the content. The display 316 typically receives an analog video signal that is modulated on a carrier corresponding to channel three, channel four or a composite channel. The set top box 208 produces a NTSC signal, for example, modulated to the appropriate channel. Other embodiments could use a video monitor or digital display instead of a television display 316. Use of a digital display alleviates the need for an analog conversion by the set top box 208 because digital displays, such as liquid crystal displays, use digital information to formulate the displayed picture.

The wireless input device 318 allows interaction between the user and the set top box 208. This device 318 could be a remote control, mouse, keyboard, game controller, pen tablet, or other input mechanism. An infrared transceiver on the input device 318 communicates with a similar transceiver on the set top box 208 to allow wireless communication. In other embodiments, RF link or wired link could be used instead of the infrared transceiver.

The set top box 208 has component parts that perform authentication and authorization of functional units. Included in the set top box 208 are a controller 320, memory 328, a printer port 332, a network port 336, an access control processor 340, a display interface 344, and an infrared (IR) port 348. These blocks communicate with each other over a bus 330 where each block has a different address to uniquely identify it on the bus 330. Typically, the set top box 208 is a separate device, but could be integrated with the TV display 316, a computer, an information appliance, a personal video recorder (PVR) or other consumer electronic component.

The controller 320 manages operation of the set top box 208 using a trusted or secure operating system. Such functions as digital object decryption and decompression are performed in the controller 320 as well as functions such as switching TV channels for the user and presenting menus to the user. Included in the controller 320 are a processor, an encryption engine, local memory, and other items common in computing systems. In some embodiments, the use of trusted or secure operating system could be avoided if adequate security is provided by other mechanisms.

The set top box 208 includes a block of memory 328. This memory 328 is solid state memory that could include RAM, ROM, flash, and other types of volatile and non-volatile memory. Objects are stored in the memory 328 for possible use at a later time. During execution, software objects are loaded into and executed within the memory 328, and also use the memory 328 for scratchpad space. Objects, keys, serial numbers and authorizations can be stored in a non-volatile portion of the memory 328 such that they are retained through a power cycle.

This embodiment includes a printer port 332 resource for interfacing to an optional printer 312. The printer port 332 is a functional unit that is not available to programs unless authorized. As explained further below, each object must have the required authorization tier to use a resource such as the printer port 332. Data is sent from the printer port 332 to the printer 312 in a serial or parallel fashion by way of a wired or wireless transport mechanism.

Stated generally, a checkpoint is a point in time or a step of processing where the authentication and/or authorization status of a functional unit is confirmed. For example, a checkpoint is encountered when printing is requested. The checkpoint authorizes and authenticates the object requesting the printing and/or the printer resource. Checkpoints are places in one object where authentication and/or authorization are run on another object (e.g., an operating system checks authentication and authorization of an application that is running). Ideally, checkpoints are performed when the purpose of the object becomes manifest. In the case of a printer port 332, its purpose becomes manifest when it is used to print something. Accordingly, a checkpoint is triggered to check the object using the printer port 332 resource when anything is printed. Typically, the checkpoint for printing is located in the operating system, but could be in any program that interacts with the printer 312.

The network port 336 is a resource that allows bi-directional communication between the set top box 208 and the MSO by way of the network 308. Included in the network port 336 are a tuner and a demodulator that tune to analog carrier channels and demodulate an MPEG data stream to allow one-way delivery of content. Also included in the network port 336 is a control data transceiver or cable modem that allows for bi-directional communication of control data information and/or content. To distribute loading of the control data path to the MSO more evenly, a store and forward methodology may be used.

Modulation of the digital video signal onto an analog signal compatible with the TV display 316 is performed by the display interface 344. As discussed above, the TV display 316 generally accepts signals modulated on channel three, channel four or a composite channel. For displays that accept a digital input, such as LCD displays, the display interface 344 performs any formatting required by the digital input.

The IR port 348 is a resource that communicates bi-directionally with a wireless input device 318. Included in the IR port 348 is an IR transceiver that provides the wireless communication path with the input device 318. Other electronics in the IR port 348 convert analog signals received by the transceiver to a corresponding digital signal and convert analog signals sent to the transceiver from a corresponding digital signal. The controller 320 processed the digital signals so that the user can control some of the functions within the set top box 208.

The access control processor (ACP) 340 regulates security functions within the set top box 208. For example, the ACP 340 performs authentication and authorization either under the direction of the controller 320 or independent of the controller 320. To perform its tasks, the ACP 340 includes a processor, RAM and ROM that cooperate to execute software independent of the controller 320. The ACP 340 also includes a decryption engine and a hash function for deciphering content and calculating signatures. Checkpoints are embedded into the software run that trigger the ACP 340 to perform security checks. In this embodiment, the ACP 340 is implemented in hardware, but other embodiments could perform the functions of the ACP 340 in software.

The ACP 340 can also shadow the operating system (OS) to assure proper functioning of the OS. By watching the launch of software objects, the ACP 340 can monitor which application software objects are running. If necessary, the ACP 340 can kill running applications if a checkpoint detects an error or if authorization expires. Further, the ACP 340 could monitor memory 328 to detect any application not authorized to be in memory 328. Scratchpad memory size could also be monitored to detect applications hiding in scratchpad memory. Additionally, the ACP 340 could randomly execute checkpoints on the objects in memory to confirm their authorization and/or authenticity. Problems encountered by the ACP 340 are reported to either the OS or the MSO. In these ways, the ACP 340 acts as a software security guard bot within the set top box 208 such that aberrant behavior is detected and reported.

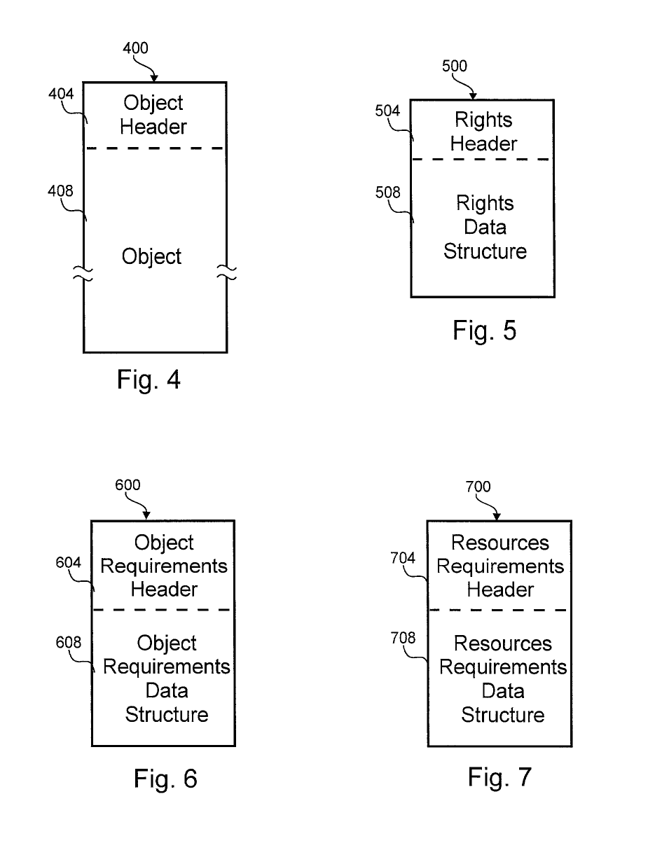

With reference to FIG. 4, an embodiment of an object message 400 is shown in block diagram form. Object messages 400 deliver functional units in electronic form to the set top box 208 from the network 308 such that information may be sent to the set top boxes 208 after they are fielded. Forming the object message 400 are an object header 404 and an object 408. The requirements for the object 408 are not included in the object message 400 in this embodiment, however, other embodiments could include requirements for the object 408 in the object message 400. The tier requirements for the object 408 are transported separately in an object requirements message. Although not shown in FIG. 4, checksums are used to validate that the object message 400 is transported to the set top box 208 from the headend without errors.

The object header 404 includes attributes for the object message 400. Included in the object header 404 are a header length, an object length, a functional unit identifier, a software version, and a domain identifier. The header and object lengths respectively indicate the lengths of the object header 404 and the object 408. The functional unit identifier provides a unique code that allows attributing tier requirement information to the object message 400. The software version indicates the revision number of the object. Different MSOs are assigned domain identifiers such that all of the set top boxes 208, which might receive an object 408, can screen for objects 408 associated with their domain.

The object 408 includes content the system 200 is designed to deliver to set top boxes 208. Upon download of the object 408, it is authenticated and authorized to verify the source of the object message 400 and availability of the object 408 to the receiving set top box 208. Several types of content or information can be embedded in an object, such as executable programs, firmware upgrades, run-time programs (e.g., Java® or ActiveX®), programming schedules, billing information, video, audio, and/or data. The object 408 can be used immediately after authentication and authorization or at a later time. Additionally, authorization can be programmed to expire after a certain amount of time or can be rechecked periodically as the object 408 is used.

Referring next to FIG. 5, an embodiment of a “rights” message 500 is shown in block diagram form. The rights message 500 conveys rights to use a functional unit. Typically, there is one rights message 500 for each set top box 208, which specifies any rights for the functional units in the set top box 208. To determine authorization, requirements associated with the functional unit are checked against the rights of the set top box 208 to determine if interaction with another functional unit is authorized. The rights message 500 allows remotely adding new rights to a functional unit associated with the set top box 208 to authorize different features and/or functions. Although not shown, the rights message 500 includes a checksum to verify the integrity of the message 500 during transport.

The rights header 504 includes attributes for the rights message 500. Included in the rights header 504 are a header length, a rights data structure length, a set top box identifier, and a domain identifier. The header length and the rights data structure length respectively indicate the lengths of the rights header 504 and the rights data structure 508. The set top box identifier provides a unique code that allows attributing the rights message 500 to a specific set top box 208 in the domain.

Rights are conveyed to the functional units using the information in the rights data structure 508. A given functional unit may have rights to use several other functional units by conveyance of an individual right or a global right by analyzing the rights data structure 508. A right is also called a tier and may allow use of any number of functional units that are authorized by a particular tier. The functional unit may be already in the set top box 208 or may be downloaded at some later time using an object message 400.

Referring next to FIG. 6, an embodiment of an object “requirements” message 600 is shown in block diagram form. The object requirements message 600 is used to specify the requirements for a corresponding object 408 in the set top box 208. Included in the object requirements message 600 are a requirements header 604 and a requirements data structure 608. Although not shown, the object requirements message 600 includes a checksum to verify the integrity of the message 600 during transport.

The requirements header 604 includes attributes for the object requirements message 600. Included in the requirements header 604 are a header length, a requirements data structure length, a functional unit identifier and a domain identifier. The header and requirements data structure lengths respectively indicate the lengths of the requirements header 604 and the requirements data structure 608. Every resource and object has a functional unit identifier that uniquely labels that functional unit. The functional unit identifier allows attributing the object requirements to an object 408. Different MSOs are assigned domain identifiers such that all of the set top boxes 208 which might receive the object requirements message 600 can screen for messages 600 associated with their domain.

The requirements data structure 608 allows the MSO to specify the tier requirements corresponding to the object 408. In the data structure 608, the functional unit identifier is mapped to one or more tier requirements. If a right to any of the required tiers is downloaded in a rights message 500, that object 408 is authorized for use. For example, the e-mail object could require any of tiers ten, twenty or thirty to be present. If the rights message 500 includes tier twenty, the set top box 208 is authorized to use the e-mail program.

The object requirements message 600 is uniquely coupled with the associated object message 400 by a signature over both messages. Even though transported separately, the common signature assures both messages 400, 600 are not modified during transport.

Referring next to FIG. 7, an embodiment of a resources “requirements” message 700 is shown in block diagram form. The resources requirements message 700 is used to specify the requirements for all the resources in the set top box 208. Included in the resources requirements message 700 are a requirements header 704 and a requirements data structure 708. Although not shown, the resources requirements message 700 includes a checksum to verify the integrity of the message 700 during transport.

The requirements header 704 includes attributes for the resources requirements message 700. Included in the requirements header 704 are a header length, a requirements data structure length, and a domain identifier. The header and requirements data structure lengths respectively indicate the lengths of the requirements header 704 and the requirements data structure 708. Different MSOs are assigned domain identifiers such that all of the set top boxes 208, which might receive a resources requirements message 700, can screen for messages 700 associated with their domain.

The resources requirements data structure 708 allows the MSO to limit access of any resource to predetermined subset of all set top boxes 208. Included in the resource requirements data structure 708 are entries for each resource in the set top box 208 where the entries are labeled with their respective functional unit identifier. Each functional unit identifier is mapped to one or more requirements in the data structure 708. If any of the required tiers for a resource has been downloaded in the rights message 500, that functional unit is authorized for use. For example, if the printer port requires tier twenty and rights to that tier are not granted, the printer port in not accessible by any program.

Table 1 shows an example of the tier requirements mapping for the functional units in a set top box 208. The requirements for each object 408 are received in an object requirements message 600, and the requirements for all resources are received in a resources requirements message 700.

TABLE 1

| Functional | | Tier |
|---|---|---|
| Unit ID | Functional Unit | Requirements |
| 0 | Operating System Object | 10 |
| 1 | E-mail Object | 10, 40 |
| 2 | E-mail Use of Printer Port Resource | 40, 70 |
| 3 | Word Processor Use of Printer Port | 60, 80 |
| 4 | Word Processor Object | 50, 60 |
| 5 | Fire Wire Port Resource | None |
| 6 | IR Port Resource | 90 |

The physical printer port 332 may have a number of resources assigned to it that correspond to objects 408. For example, the ability of the word processor object to use the printer port 332 is resource three, while the ability of the e-mail object to use the printer port 332 is resource two. For example, the word processor could be allowed to print by having tier sixty or eighty, but the e-mail program could be denied the ability to print by not having tier forty or seventy. In this way, the ability of individual software objects 408 to access the printer port 322 can be regulated.

Granting rights to a tier may enable use of more than one functional unit. In other words, each tier may correspond to a package of functional units. For example, every functioning set top box 208 in the domain may be given tier ten as a default condition. Referring the example of Table I, tier ten would allow use of the operating system and e-mail objects. Further functionality could be made available to the user by granting rights to additional tiers as desired by the MSO.

The mapping of tier requirements allows offering software objects with different functionality. For example, the word processor object could be sold with two different feature sets. If tier sixty were procured in a rights message 500, the user could use the word processing program and print from that program. However, the user could not print from the word processing program, if tier fifty were procured instead of tier sixty. The user could later upgrade from tier fifty by procuring tier eighty to allow printing from the word processor.

Use of the set top box 208 could be disabled by the MSO in several ways. The operating system object assigned to functional unit zero is required for proper functioning of the set top box 208. By sending a rights message 500 that did not have tier ten, which is required by the operating system object, the set top box 208 ceases to perform properly. The ability to disable the operating system object would not interrupt the ability to receive additional rights messages 500 that could re-enable operation of the set top box 208. Less drastic measures could be taken to disrupt operation of the set top box 208, such as removal of tier ninety, which corresponds to the IR port 348. Without use of the remote control 318, the set top box functionality is severely curtailed.

Functional units that have no assigned requirement tiers cannot be enabled by a rights message 500. In the example of Table I, use of the fire wire port cannot be authorized by any requirements. Accordingly, the set top box 208 cannot use this resource regardless of what tier rights it may posses. Later, a new resources requirements message 700 could be sent to replace the old one. The new resources requirements message 700 could have a tier assigned to the fire wire port resource such that a rights message could authorize its use. The checking of tier requirements against tier rights is performed during the authorization process. Authorization and/or authentication is performed whenever a checkpoint is encountered.

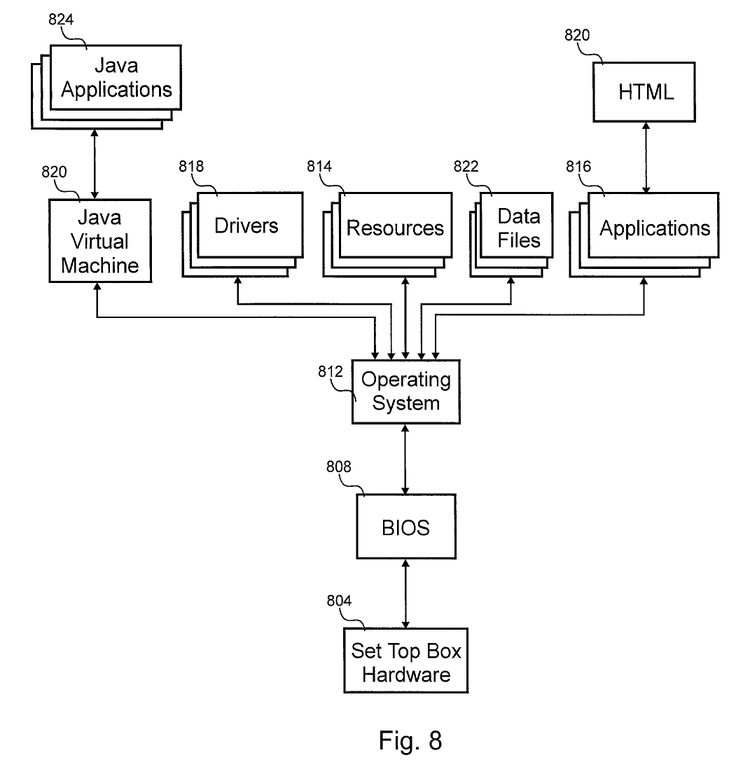

With reference to FIG. 8, some of the functional units of a set top box 208 are shown. Functional units toward the bottom of FIG. 8 are superordinate to the functional units near the top of FIG. 8. That is to say, functional units toward the top of FIG. 8 are subordinate to those lower in the figure. In this embodiment, superordinate functional units are responsible for imposing checkpoints on subordinate functional units. For example, the hardware 804 imposes checkpoints upon the BIOS 808, OS 812 and so on up the subordination hierarchy. The BIOS 808 imposes checkpoints on the OS 812, but not upon the hardware 804. Functional units in the same ordination stratum can impose a checkpoint on another functional unit in that stratum when they interact. For example, an application 816 can require execution of a checkpoint on a driver 818.

Superordinate functional units are designed to initiate execution of the checkpoints in conjunction with the ACP 340 and subordinate objects are designed to have checkpoints imposed upon them. For example, the BIOS 808 requires execution of a checkpoint upon the OS 812 during the boot process, during execution and/or periodically while running. Driver objects 818 are subject to checkpoints when installed or exercised during normal operation. Data file objects 822 are subject to checkpoints whenever the data in the file is accessed. An HTML object 828 is reviewed as part of a checkpoint whenever the HTML object 828 is interpreted by a browser application 816.

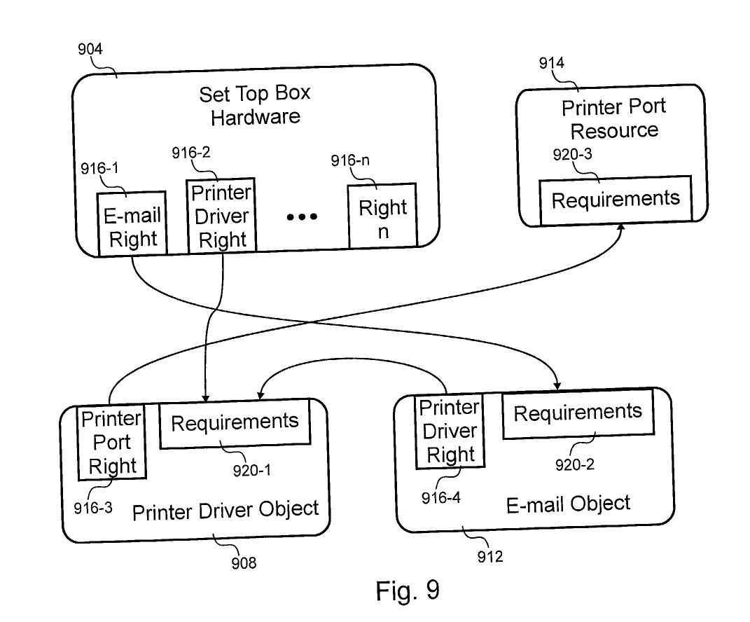

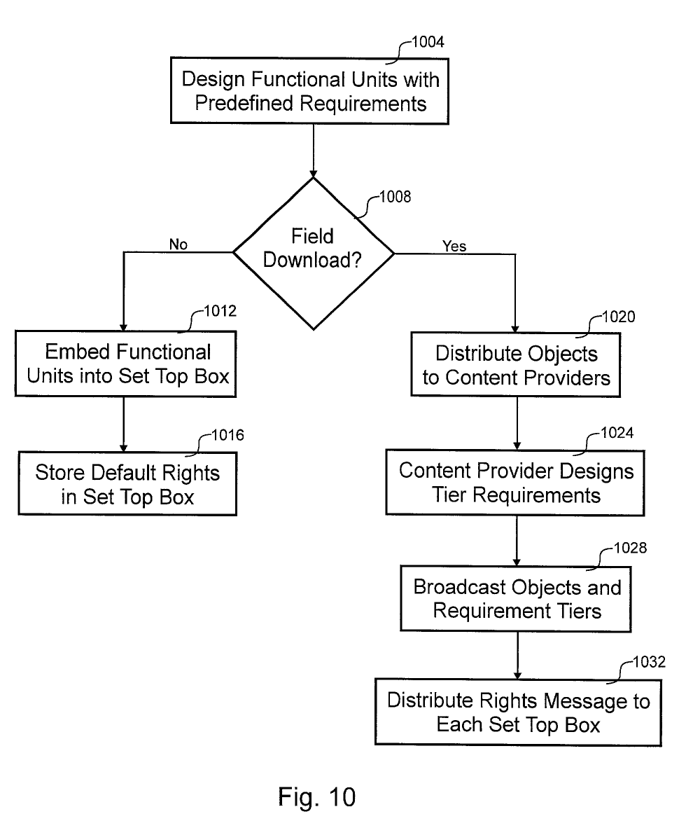

Referring next to FIG. 9, one embodiment of interaction between functional units is shown in block diagram form. In this simplified example, the functional units associated with the set top box 208 include a set top box resource 904, a printer driver object 908, an e-mail object 912, and a printer port resource 916. During the normal interaction of these functional units, checkpoints are encountered that trigger authorization checks. Table 2 correlates rights to requirements for each functional unit in FIG. 9. The functional unit identifier serves to correlate the functional units with the rights messages 500.

TABLE 2

| Functional | | | |
|---|---|---|---|
| Unit ID | Functional Unit | Requirements | Rights |
| 904 | Set Top Box | NA | E-mail, Printer Driver, etc. |
| 912 | E-mail | Yes | Printer Driver |
| 908 | Printer Driver | Yes | Printer Port |
| 914 | Printer Port | Yes | None |

The set top box resource 904 is superordinate to the email object 912. When the email object 912 is loaded, a checkpoint in the object 912 checks for proper rights. The proper rights are defined by the requirements 920-2 of the email object 912 itself. If the e-mail right 916-1 meets the standards of the e-mail object requirements 920-2, the e-mail object 912 continues execution past the checkpoint. The ACP 340 actually performs the authentication after the e-mail right 916-1 and e-mail object requirements 920-2 are respectively loaded.

After the user receives the set top box 904, the user can add an optional printer 312. In this embodiment, the ability to print is an added feature that is not included in all set top boxes 904. If the printer 312 is a purchase sanctioned by the MSO, printer driver rights 916-2, 916-4 and a printer port right 916-3 are sent in rights messages 500 to the set top box 904 from the headend of the MSO.

Some embodiments could provide rights to a subset of the functional units capable of using the printer port 920-3. For example, the e-mail object 912 could be given the printer driver right 916-4, but the set top box resource 904 would not receive the printer driver right 916-2. In this way, only the email object 916-2 could use the printer port 920-3 and the other objects could not.

Hooking the printer to the printer port can trigger display of a message on the TV 316 that asks for a secret code included with the printer 312. After the user enters the secret code, a request for the rights messages 500 that enable the printer is made to the MSO. Once the MSO receives and verifies the secret code, an enabling set of rights messages 500 are sent encrypted in a key based upon the secret code. In this embodiment, the printer driver object 908 is factory loaded, but other embodiments could load this object 908 when needed using an object message 400.

While the e-mail object 912 is running, the user may try to print an e-mail message. Several checkpoints authenticate the proper rights 916 are present before printing. The e-mail object 912 calls the printer driver 908 with the information requiring printing. A checkpoint in the printer driver 908 stops processing until the authorization of the e-mail object 912 is checked. A printer driver right 916-4, downloaded when the printer was purchased, is loaded into the ACP 340 along with the printer driver requirements 920-1 for authentication. Presuming authentication is successful, the printer driver object 908 formats the print information for the printer 312 and passes it to the printer port resource 914.

The printer port resource 914 is the hardware port that interfaces to a cable connected to the printer 312. Once information is sent to the printer port resource 914 a checkpoint pauses the processes to check that the printer driver object 908 has proper authorization. The requirements 920-3 and rights 916-3 are loaded into the ACP 340 for authentication. Once the use by the printer driver object 908 is authenticated, the remainder of the print job is spooled to the printer port resource 914 for printing.

In some embodiments, the rights 916 of one functional unit can be inherited by another functional unit. The right 916 could be conveyed to other objects 408 that might use that functional unit. For example, the right 916 to use the printer port 332 could initially be associated with the e-mail object 912 alone, where this right 916 is conveyed to e-mail object 912 when the user purchased a printer 312. At a later time, the MSO could authorize inheritance of that right 912 to all other functional units or a subset of the functional units that might use the printer port 332. In this way, additional functional units could use the print feature.

Referring next to FIG. 10, a flow diagram showing an embodiment of a process for distributing functional units is shown. This embodiment allows factory loading of functional units or field loading of objects. Other embodiments could field load resources also, but this is not done from a remote location such as the MSO. The process begins in step 1004 where the functional units are designed. The functional units include hardware and software. Some software could be developed by third parties and provided to the MSO for distribution. The various default requirement tiers for the functional units are also defined in step 1004.

A determination is made in step 1008 as to whether the functional unit is being installed in the factory or in the field. As those skilled in the art appreciate, resources are typically physical devices that are installed at the factory or by a technician in the field. Electronically storable objects can generally be installed in the factory or the field, however, certain objects are installed in the factory such as portions of the operating system 612 without need for a technician to provide a minimum functionality to the set top box 208.

If the particular functional unit being installed is factory loaded, processing continues to step 1012 where the functional units are installed into the set top box 208. Typically, the physical devices and most of the objects are factory installed such that the set top box is functional before shipment to the user. Certain objects 408, however, are loaded into the set top box 208 after fielding it.

For field loaded objects, processing goes from step 1008 to step 1020 where the objects are distributed to content providers. The distribution process includes electronically sending the object 408 by some type of data link such as a packet switched network. In step 1024, the content provider assigns functional unit identifiers to the functional units. Tier requirements for each functional unit are determined according to a marketing plan of the MSO. The content provider embeds the objects 408 in object messages 400, and broadcasts the objects 408 and object requirements messages 600 to set top boxes 208 over a control data channel in step 1028.

Once all the functional units and corresponding tier requirements are sent to the set top boxes 208, the rights for each box 208 are distributed. A billing program is checked to determine the features desired by the user. Once the features are known, the appropriate tier rights message 500 is sent to each set top box 208 in step 1032. In this way, the MSO controls use of functional units within the set top box 208 from a remote location.

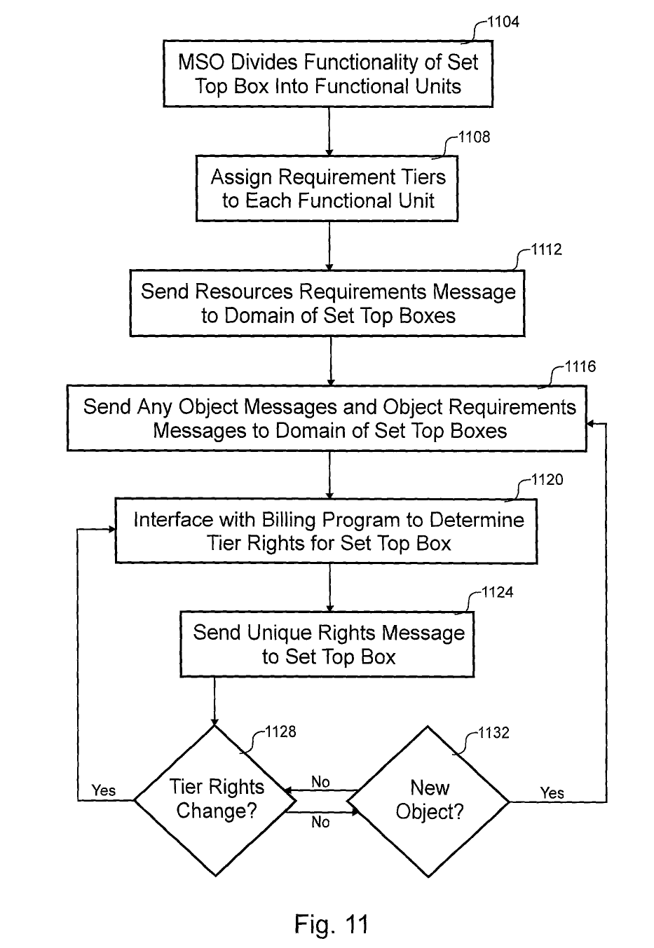

With reference to FIG. 11, a flow diagram depicting an embodiment of a process for sending control data information is shown. The MSO controls access to functional units that are in set top boxes 208 and are remotely located from the MSO. The process begins in step 1104 where the MSO divides the functionality of the set top box 208 into a number of functional units. The granularity of the division should match any marketing program. For example, there should be a resource assigned for each object 408 that may use the printer port 332 if the ability to print for each object 408 is to be independently regulated.

Once the functional units are defined, one or more tiers are assigned to that functional unit in step 1108. Care is taken to provide for packaging functional units in a manner consistent with the marketing plan. For example, if the fire wire port is not to be used in any set top box 208, no tier is assigned for that resource to effectively disable the port in all set top boxes 208 in that domain.

Once the functional units and their requirements are defined, any object and requirements messages 400, 600, 700 are distributed. In step 1112, the resources requirements message 700 is formulated and sent to all the set top boxes 208 in the domain. This message 700 specifies any tier requirements for all the resources in each set top box 208. Any resources requirements message 700 already in the set top box 208 is overwritten by the subsequent message 700. In step 1116, any object messages 400 are sent to the set top boxes 208 in the domain. An object requirements message 600 is sent for each object message 400 to specify the tier requirements for the object 408 included therein. Any object requirements message 600 already in the set top box 208 is overwritten by the subsequent message 600 using the same functional unit identifier.

Once the set top box 208 knows its requirements, the MSO determines how to distribute the tier rights for using the functional units in the set top box 208 in step 1120. This could involve interfacing with a billing program to determine rights for each user. Once these rights are known, a unique rights message is sent to the set top box 208 of each user in step 1124. At this point in the process, the set top box 208 has authorized all the functional units chosen for use in that box 208.

The MSO can add and subtract functionality from each set top box 208 in the domain. If it is determined the tier rights for a set top box need changes in step 1128, processing loops back to step 1120 where the MSO determines what rights to allow. A new rights message 500 is formulated and sent to the set top box 208.

From time to time, new objects 408 are added to the set top box 208. For example, an object 408 that includes program guide information could be downloaded daily. If it is determined there is a new object 408 that requires distribution in step 1132, processing loops back to step 1116 where the object message 400 and object requirements message 600 are formulated and sent. New rights would also be sent to enable the object 408 on the appropriate set top boxes 208 if a different functional unit identifier is used. Use of the same functional unit identifier would replace the old object 408.

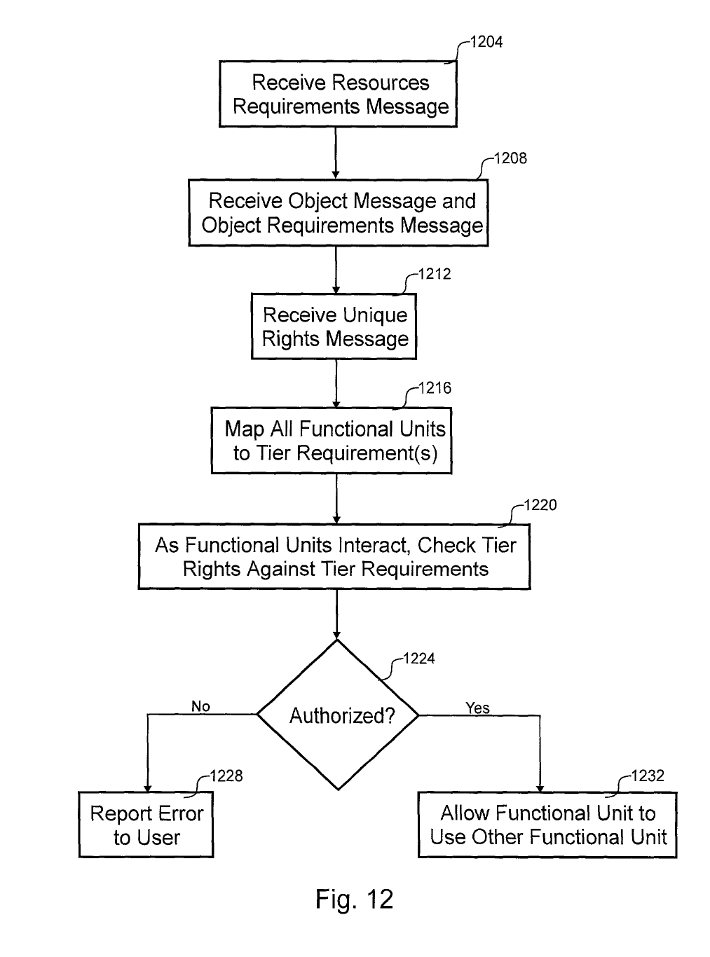

Referring next to FIG. 12, a flow diagram illustrating an embodiment of a process for receiving control data information is shown. Just as the MSO sends the control data information, the set top box 208 receives and processes the information as part of authorization. The process begins in step 1204 where a resources requirements message 700 is received. Any preexisting resources requirements message 700 is overwritten with the new message 700.

After the requirements for the resources are received, the object message(s) and object requirement message(s) are received in step 1208. At this point, all the functional units and their tier requirements are present in the set top box 208. In step 1212, a rights message 500 is received. This message 500 indicates the tiers the particular set top box is entitled to use. Once the rights are received, the requirements are mapped to them to determine the functional units that are authorized in step 1216.

As functional units interact during the normal operation of the set top box 208, checkpoints are encountered. Checkpoints may require checking authorization for use of some features by a functional unit. Authorization checks include determining if the requirements of a functional unit are satisfied by the tier rights in step 1220. If there is proper authorization as determined in step 1224, the functional unit is allowed to interact with the other functional unit in step 1232. Alternatively, an error is reported to the user and/or the MSO in step 1228 if the interaction is not authorized.

In light of the above description, a number of advantages of the present invention are readily apparent. A tier mechanism can be used to implement a wide variety of marketing programs by the MSO remotely from the users. Through the mapping of tier requirements to tier rights, authorization of functional units can be controlled in a flexible way.

A number of variations and modifications of the invention can also be used. For example, the above examples show the various control data messages being sent in a particular order. Other embodiments could send these messages in other orders. Regardless of the order of arrival, a particular functional unit may become authorized when its rights and requirements information is present in the set top box.

In some of the above embodiments, resource requirements are mapped to tiers. In other embodiments, Java™ permissions for applications, applets or other code could be tied to tiers, just like resources. Java™ code uses permissions to access things outside the Java™ sandbox. These permissions could be mapped to tiers such that if a mapped tier did not have the proper tier right, the permission would not be granted.

Although the invention is described with reference to specific embodiments thereof, the embodiments are merely illustrative, and not limiting, of the invention, the scope of which is to be determined solely by the appended claims.

What is claimed is:

1. A method for controlling access to a functional unit within a set top box, comprising:
receiving first information comprising a plurality of functional unit identifiers and one or more tier requirements respectively related to each functional unit identifier;
receiving second information comprising tier rights;
correlating the functional unit identifiers to their respective tier requirements;
interacting with the functional unit;
determining if the respective tier requirements are satisfied by the tier rights; and
authorizing further interaction with the functional unit.

2. The method for controlling access to the functional unit within the set top box of claim 1, further comprising receiving third information that replaces the tier rights.

3. The method for controlling access to the functional unit within the set top box of claim 1, wherein more than one of the tier rights could authorize further interaction with the functional unit identifier.

4. The method for controlling access to the functional unit within the set top box of claim 1, authenticating a source of at least one of the first and second information.

5. The method for controlling access to the functional unit within the set top box of claim 1, wherein the functional unit comprises a discrete entity comprising at least one of software, hardware, drivers, firmware, data, video, and audio.

6. The method for controlling access to the functional unit within the set top box of claim 1, further comprising receiving a plurality of streaming content functional units.

7. The method for controlling access to the functional unit within the set top box of claim 1, wherein the set top box is integral with an enclosure for a display.

8. A conditional access system for controlling access to functional units, comprising:
a set top box;
a functional unit associated with the set top box;
a requirements message comprising a functional unit identifier and one or more tier requirements related to the functional unit identifier, wherein the functional unit identifier is associated with the functional unit;
a rights message comprising one or more tier rights; and
an authorization function that compares each of the one or more tier requirements against the one or more tier rights in order to authorize use of the functional unit.

9. The conditional access system for controlling access to functional units of claim 8, further comprising an authentication function that authenticates a source of the rights and requirements messages.

10. The conditional access system for controlling access to functional units of claim 8, further comprising a data channel between a headend and the set top box, wherein the data channel is one of bi-directional and omni-directional.

11. The conditional access system for controlling access to functional units of claim 8, further comprising a second rights message to replace the tier rights.

12. The conditional access system for controlling access to functional units of claim 8, further comprising a plurality of streaming content functional units sent from a headend to the set top box.

13. The conditional access system for controlling access to functional units of claim 8, wherein the functional unit comprises a discrete entity comprising at least one of software, hardware, drivers, firmware, data, video, and audio.

14. The conditional access system for controlling access to functional units of claim 8, wherein the set top box is integral to an enclosure for a display.

15. A method for controlling access to remotely-located and functional units within a conditional access system, comprising:
determining first and second information to modify authorization of a remotely-located and functional unit;
sending the first information comprising a functional unit identifier and at least one tier requirement related to the functional unit identifier;
sending the second information comprising a tier right; and
causing modification of an authorization state of the remotely located functional unit corresponding to the functional unit identifier.

16. The method for controlling access to remotely-located and functional units within the conditional access system of claim 15, further comprising:
sending third information comprising a replacement tier right; and
causing further modification of the authorization state of the remotely-located and functional unit corresponding to the functional unit identifier.

17. The method for controlling access to remotely-located and functional units within the conditional access system of claim 15, wherein the authorization state is one of authorized and unauthorized.

18. The method for controlling access to remotely-located and functional units within the conditional access system of claim 15, further comprising generating a signature over at least one of the first and second information.

19. The method for controlling access to remotely-located and functional units within the conditional access system of claim 15, wherein more than one tier right could authorize use of the remotely-located and functional unit corresponding to the functional unit identifier.

20. The method for controlling access to remotely-located and functional units within the conditional access system of claim 15, further comprising sending a plurality of streaming content functional units to a remote location.

21. The method for controlling access to remotely-located and functional units within the conditional access system of claim 15, wherein the remotely-located and functional unit comprises a discrete entity comprising at least one of software, hardware, drivers, firmware, data, video, and audio.
